(19) United States
(12) Patent Application Publication
(10) Pub. No.: US 2011/0006687 A1
(43) Pub. Date: Jan. 13, 2011

(54) METHOD AND GENERATOR CIRCUIT FOR PRODUCTION OF PLASMA BY MEANS OF RADIO-FREQUENCY EXCITATION

(75) Inventor: Roland Gesche, Seligenstadt (DE)

Correspondence Address: CANTOR COLBURN LLP, 20 Church Street, 22nd Floor, Hartford, CT, 06103, US

(73) Assignee: AURION ANLAGENTECHNIK GMBH, Seligenstadt (DE)

(21) Appl. No.: 12/743,159

(22) PCT Filed: Oct. 28, 2008
(86) PCT No.: PCT/EP08/64620

§ 371 Date: Sep. 22, 2010

(30) Foreign Application Priority Data
Nov. 14, 2007 (DE) 10 2007 055 010.5

(51) Int. Cl. H01J 7/00

(52) U.S. Cl. 315/111.21

(57) ABSTRACT

Method and generator circuit for generating plasmas by means of radiofrequency excitation

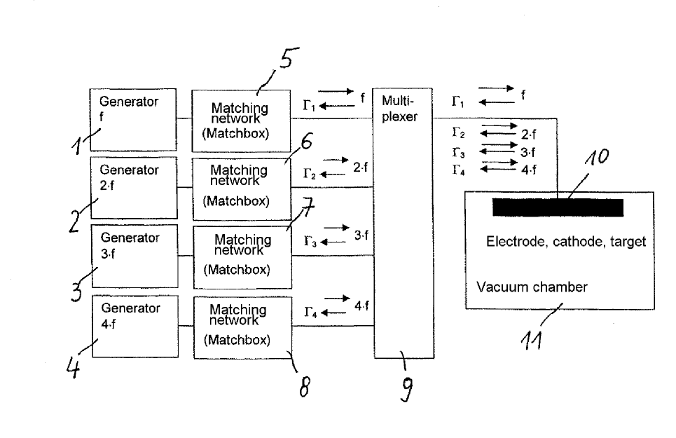

In order to provide a voltage that maintains the plasma, according to the method, a high-frequency voltage having a defined operating frequency and at least one further high-frequency voltage having in each case a multiple of said operating frequency and in each case an adjustable amplitude and phase are superposed in a phase-locked manner.

For a corresponding generator circuit, at least two radiofrequency power generators (1 to 4) are provided, of which one (1) operates at a defined operating frequency (f) and the other(s) (2 to 4) operate(s) at in each case a multiple of said operating frequency (f). All the radiofrequency power generators (1 to 4) are coupled to one another in a phase-locked manner and the relative phase angle and also the respective amplitude of each radiofrequency power generator (1 to 4) can be individually regulated by means of a dedicated matching circuit (5 to 8).

As an alternative thereto, an oscillator operating at a defined operating frequency (f) and at least one further frequency multiplier connected downstream of the oscillator can be provided, which generate(s) harmonics of said operating frequency (f).

### TECHNICAL FIELD

The invention relates to a method and a generator circuit for generating plasmas by means of radiofrequency excitation.

### BACKGROUND

Plasmas are used in many sedimentation, etching and layer forming processes (for example RF sputtering, PECVD). The excitation of plasmas by means of DC voltage, microwaves or by radio frequency is known. The present invention is concerned with excitation by means of radio frequency, which is suitable for sputtering processes, in particular.

In a plasma generator based on radiofrequency excitation, a power generator is connected to a plasma electrode in a vacuum chamber via a matching network, in order to carry out a low-pressure plasma process. Generators having a frequency of f=13.56 MHz at a power of 300 W to 50 kW are typical. The matching network is set for the operating frequency of the generator such that the latter is operated at its rated impedance.

If appropriate, a second plasma generator is also used, which additionally couples radio frequency via an induction coil surrounding the vacuum chamber into the chamber and thus energy into the plasma space.

As a result of the nonlinearity of the impedance of the plasma, harmonics having multiples of the frequency of the generator arise, which flow from the electrode back into the matching network. The reflection factors encountered by these harmonics are not defined and are not controlled. At the plasma electrode this gives rise to a waveform of the voltage which is periodic with the operating frequency of the generator, but which has an uncontrolled profile within the voltage period. Lack of reproducibility of a process, “mystical” process changes after service, repair or exchange of radiofrequency components are the consequence. The process becomes dependent on the design and construction of the radiofrequency supply, in particular of the matching network.

According to U.S. Pat. No. 6,537,421 B2 a plasma generator is known in which, in order to overcome this problem, filters that are respectively tuned to a harmonic of the operating frequency of the radiofrequency generator are connected between plasma electrode and matching network.

According to U.S. Pat. No. 7,084,369 B2 a further solution is known, according to which the reflected waves are divided in a frequency-selective multiplexer. They are subsequently passed in each case to adjustable impedances, such that they find defined reflection factors. Consequently, although reproducible conditions can be created, the influence on the waveform of the radiofrequency excitation is limited.

### BRIEF SUMMARY

The invention provides a method and a generator circuit for generating plasmas by means of radiofrequency excitation with which the time profile of the radiofrequency excitation can be controlled in a reproducible manner.

Accordingly, in order to provide a voltage that maintains the plasma, a high-frequency voltage having a defined operating frequency and at least one further high-frequency voltage having in each case a multiple of said operating frequency and in each case an adjustable amplitude and phase are superposed in a phase-locked manner.

In order to realize the method, at least two radio frequency power generators are provided, of which one operates at an operating frequency and the other(s) operate(s) at in each case a multiple of said operating frequency. All the radiofrequency power generators are coupled to one another in a phase-locked manner. The relative phase angle and the respective amplitude of a radiofrequency power generator can expediently be individually regulated. The voltages of the radiofrequency power generators with their respective signal frequency are in each case passed via a dedicated matching circuit and superposed on the supply line to the plasma electrode by means of a multiplexer. By means of the setting of the different amplitudes and phase angles, the waveform of the voltage can be controlled in a targeted manner.

Instead of a plurality of radiofrequency power generators, alternatively it is also possible to use an oscillator and at least one frequency multiplier, which generate(s) the harmonics. A respective phase shifter is then expediently connected downstream of the frequency multipliers. The coupling to the plasma electrode is effected via a broadband amplifier or a plurality of narrowband amplifiers for the respective frequency.

By way of example, the so-called self-bias DC voltage can be influenced by means of the method. Besides a sinusoidal voltage, it is then also possible to set a small peak voltage (rectangular voltage) or a high peak voltage (pulse voltage). This affords diverse possibilities for controllable and reproducible process configuration.

### BRIEF DESCRIPTION OF THE DRAWING

The invention will be explained in greater detail below on the basis of an exemplary embodiment. The associated drawing shows a generator circuit according to the invention.

### DETAILED DESCRIPTION

The output of a radiofrequency power generator 1, which generates an operating frequency f, is connected via a matching network 5 to a multiplexer 9, the output of which in turn is connected to an electrode 10 in a vacuum chamber 11. The matching network 5 is tuned to the operating frequency f of the radiofrequency power generator 1.

Further radiofrequency power generators 2, 3, 4 respectively operate at n times the operating frequency f, wherein n is 2, 3 and 4, for example, that is to say that they respectively generate a harmonic of the operating frequency f. All the radiofrequency power generators 1 to 4 are coupled to one another in a phase-locked manner (for example by synchronization, not shown). The radiofrequency power generators 1 to 4 are connected to the electrode 10 of the vacuum chamber 11 via the multiplexer 9. Each harmonic is passed via a dedicated matching network 6, 7, 8 to the multiplexer 9. The harmonics can thus in each case be matched, that is to say set according to absolute value and phase, and thus be tuned to the harmonics arising in the plasma by virtue of the fact that they encounter reflection factors Γ2, Γ3, Γ4 upon flowing back.

With the excitation of the harmonics, it is then possible to generate a sinusoidal or else a pulsed or a rectangular voltage for the plasma depending on the requirements.

1. A method for setting a waveform of a radiofrequency excitation voltage for plasmas, wherein, in order to provide a voltage that maintains the plasma, a high-frequency voltage having a defined operating frequency and at least one further high-frequency voltage having in each case a multiple of said operating frequency and in each case an adjustable amplitude and phase are superposed in a phase-locked manner.

2. The method as claimed in claim 1, wherein a self-bias DC voltage is adjusted in the plasma.

3. The method as claimed in claim 1, wherein at least two radiofrequency power generators are provided, of which one operates at an operating frequency and the other(s) operate(s) at in each case a multiple of said operating frequency.

4. The method as claimed in claim 3, wherein a relative phase angle and a respective amplitude of the radiofrequency power generators are individually regulated.

5. The method as claimed in claim 1, wherein a small peak voltage or a high peak voltage is set.

6. A generator circuit for generating plasmas by means of radiofrequency excitation for realizing the method of claim 1, wherein, in order to set a waveform of a radiofrequency excitation voltage for plasmas, provision of a voltage that maintains the plasma is provided by means of at least two radiofrequency power generators of which one operates at defined operating frequency and the other(s) operate(s) at in each case a multiple of said operating frequency, all the radiofrequency power generators are coupled to one another in a phase-locked manner and a relative phase angle and also a respective amplitude of each radiofrequency power generator can be individually regulated by means of a dedicated matching circuit.

7. The generator circuit as claimed in claim 6, wherein the radiofrequency power generators are connected to an electrode of a vacuum chamber via a multiplexer.

8. A generator circuit for generating plasmas by means of radiofrequency excitation for realizing the method as claimed claim 1, wherein, in order to set a waveform of a radiofrequency excitation voltage for plasmas, for providing a voltage that maintains the plasma, an oscillator operating at a defined operating frequency and at least one further frequency multiplier connected downstream of the oscillator are provided, which generate(s) harmonics of said operating frequency.

9. The generator circuit as claimed in claim 8, wherein a respective phase shifter is connected downstream of the frequency multipliers.

10. The generator circuit as claimed in claim 8, wherein the output voltage of the frequency multipliers is passed to a broadband amplifier.

11. The generator circuit as claimed in claim 8, wherein an amplifier is connected downstream of each frequency multiplier.

12. The generator circuit as claimed in claim 6, wherein means for setting a self-bias DC voltage in the plasma are provided.
